(19) United States
(12) Patent Application Publication
(10) Pub. No.: US 2006/0026642 A1
(43) Pub. Date: Feb. 2, 2006

(54) Method and apparatus for predicting a number of individuals interested in an item based on recommendations of such item

(75) Inventors: David J. Schaffer, Wappingers Falls, NY (US); Yasser H Alsafadi, Yorktown Heights, NY (US); Amr F Yassin, Chesterfield, MO (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/538,210

(22) PCT Filed: Dec. 10, 2003
(86) PCT No.: PCT/IB03/05811

§ 371 Date: Jun. 9, 2005

Related U.S. Application Data
(60) Provisional application No. 60/432,541, filed on Dec. 11, 2002.

(51) Int. Cl. H04N 7/025; H04N 7/10; H04N 5/445; G06F 13/00

(52) U.S. Cl. 725/46; 725/34; 725/35

(57) ABSTRACT

A method (800) and apparatus (100) are disclosed for predicting a level of interest in an item, such as the size of an audience for a television program, based on the selection history (120) of multiple users and the extent to which the item is recommended (220) to the multiple users. The size of an audience for a given program can be predicted based on, for example, the percentage of users to which the given program is “highly recommended.” A method (900) for calibrating the accuracy of the predictions using measurement data indicating the actual size of the audience is also disclosed. A comparison of the predicted and actual audiences allows a correction factor to be generated to improve subsequent predictions.

### CROSS-REFERENCE TO RELATED APPLICATIONS

The present application is related to U.S. patent application Ser. No. 09/953,385, entitled “Four-Way Recommendation Method and System Including Collaborative Filtering,” filed Sep. 10, 2001, (Attorney Docket Number US010128) and U.S. patent application Ser. No. 10/014,194, entitled “Method and Apparatus for Recommending Items of Interest to a User Based on Recommendations for One or More Third Parties,” filed Nov. 13, 2001, (Attorney Docket Number US010571), each incorporated by reference herein.

The present invention relates to methods and apparatus for predicting a level of interest in an item, such as the size of an audience for a television program, and more particularly, to techniques for predicting a number of individuals that will be interested in an item using recommendations of the item.

A number of recommendation tools are available that recommend television programs and other items of interest. Television program recommendation tools, for example, typically apply user preferences to an electronic program guide (EPG) to obtain a set of recommended programs that may be of interest to one or more users. Electronic program guides identify available television programs, for example, by title, time, date and channel. Generally, television program recommendation tools obtain the preferences of a user using implicit or explicit techniques (or both). Implicit television program recommendation tools generate television program recommendations based on information derived from the viewing history of the user. Explicit television program recommendation tools, on the other hand, explicitly question users about their preferences for certain program attributes, such as title, genre, actors, channel and date/time, to derive user profiles and generate recommendations.

An explicit recommendation tool must be initialized, requiring each new user to respond to a very detailed survey specifying their preferences at a coarse level of granularity. Likewise, implicit television program recommendation tools require a significant amount of time to learn the user's viewing preferences. Thus, a recommendation tool is said to exhibit a “cold start” with a new user, since a recommendation tool is typically unable to make valuable recommendations when the recommendation tool is first obtained. The effectiveness of the recommendation tool, however, increases over time as the user interacts with the system.

In order to address the cold start problem, a number of recommendation tools have been proposed or suggested that make recommendations to a new user based on the viewing history or purchase history of other individuals (collectively, a “selection history”) or based on recommendations that were generated for other individuals. For example, U.S. patent application Ser. No. 10/014,195, entitled “Method and Apparatus for Recommending Items of Interest Based on Stereotype Preferences of Third Parties,” filed Nov. 13, 2001, (Attorney Docket Number US010575), incorporated by reference herein, describes a recommendation tool that recommends items of interest to a user, before a selection history of the user is available. The selection history of other users are processed to generate stereotype profiles that reflect the typical patterns of items selected by representative users. A new user can then select the most relevant stereotype(s) from the generated stereotype profiles and thereby initialize his or her profile with the items that are closest to his or her own interests.

In addition to recommending items of interest to a given user, it would be useful to predict a number of individuals that will be interested in an item, such as the size of an audience for a television program. Typically, the audience for a given television program is measured following a broadcast by determining the television channels that the members of a given population selected. Nielsen Media Research, for example, uses a panel of households, often referred to as “Nielsen Families,” to measure television viewing. Such measurement techniques, however, can only measure the size of the audience for a program that has already been presented.

A need therefore exists for methods and apparatus for predicting a level of interest in an item, such as the size of an audience for a television program. A further need exists for methods and apparatus for predicting a level of interest in an item based on the extent to which the item was recommended to potential users.

Generally, a method and apparatus are disclosed for predicting a level of interest in an item, such as the size of an audience for a television program, based on the selection history of multiple users and the extent to which the item is recommended to the multiple users. The multiple users may be, for example, the subscribers of a cable or satellite television service provider in a geographic area. A service provider can predict the size of an audience for a given program based on the percentage of its subscribers to which the given program is “highly recommended.” In this manner, the granularity of the predictions generated by the present invention can vary from a local area to a national area, in accordance with the geographic scope of the subscribers. A given program can be considered “highly recommended” to a subscriber, e.g., if the program (i) had a program recommendation score exceeding a predefined threshold; or (ii) is in a top-N list of recommended programs for the user in a given time interval.

According to another aspect of the invention, a method for calibrating the accuracy of the predictions using measurement data indicating the actual size of the audience is disclosed. The actual measurement data may be obtained, for example, from a research firm, a survey, or by monitoring the actual viewing of the subscribers. A comparison of the predicted and actual audiences allows a correction factor to be generated to improve subsequent predictions. In addition, a feedback mechanism updates the feature counts of a given user, based on the shows that are actually watched (and optionally, not watched). The accuracy of the user recommendations will increase over time as the users interact with the system. It thus becomes more likely that only a single program is highly recommended for a given user for a given time slot. In this regard, the predictions will “self correct” as the viewing histories of the multiple users increase over time. Thus, the predictions generated by the present invention will improve over time and can compensate for errors based on both sampled and unsampled users.

The predictions generated by the present invention can be employed, for example, by broadcasters to dynamically adjust the price of advertising based on the predicted size of an audience. In addition, the generated predictions can be employed by advertisers to dynamically adjust the content of advertising presented during a given program to appeal to the predicted audience for the program. A manufacturer of an item or the publisher of a book or other printed material can use the predictions provided by the present invention to determine, for example, how many items to manufacture or how many copies of a book to print.

A more complete understanding of the present invention, as well as further features and advantages of the present invention, will be obtained by reference to the following detailed description and drawings.

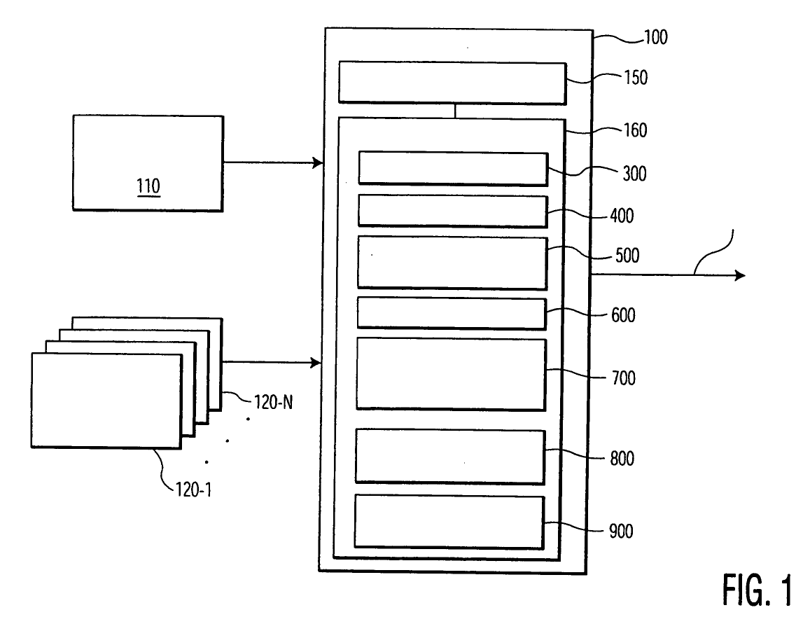

FIG. 1 is a schematic block diagram of one embodiment of an audience predictor in accordance with the present invention;

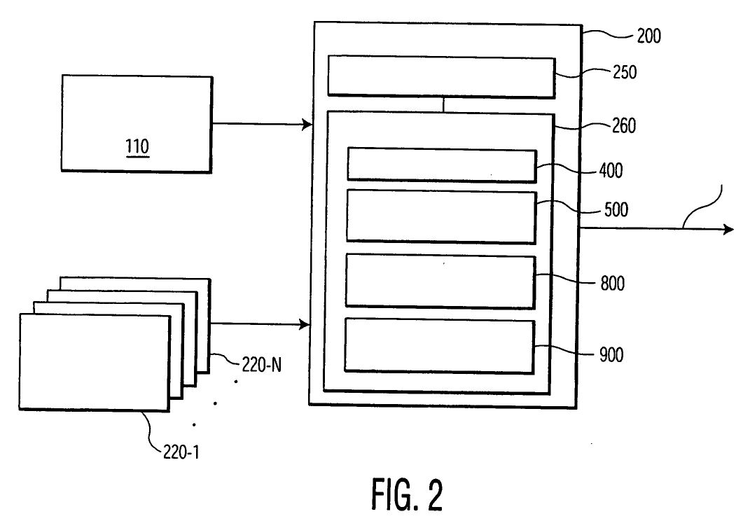

FIG. 2 is a schematic block diagram of a second embodiment of an audience predictor in accordance with the present invention;

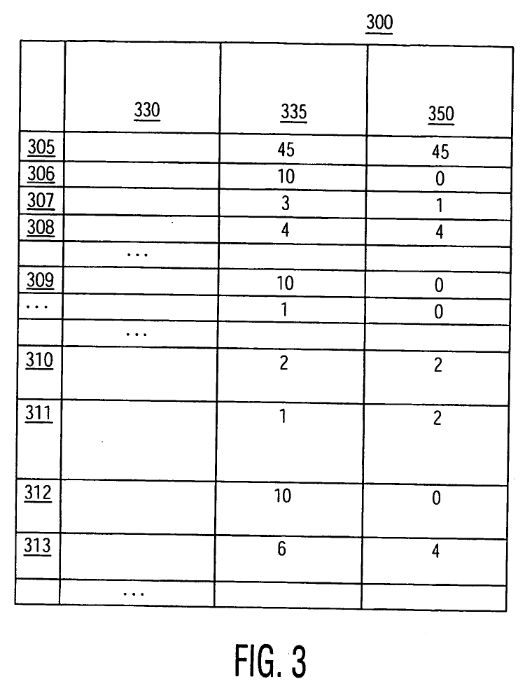

FIG. 3 is a sample table from the user profile database of FIG. 1;

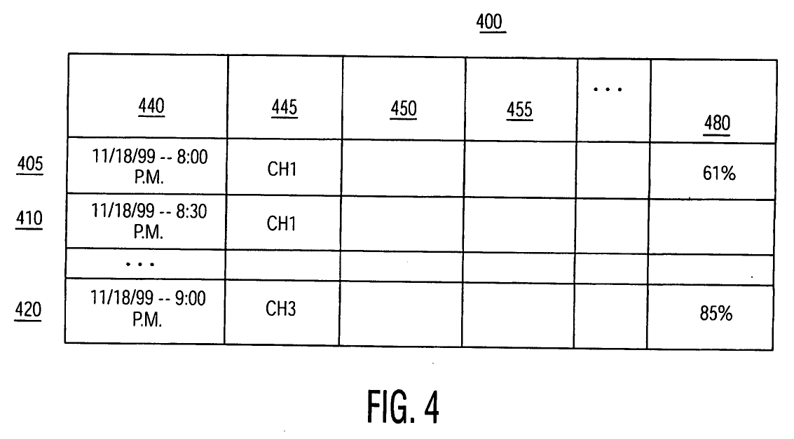

FIG. 4 is a sample table from the program database of FIGS. 1 and 2;

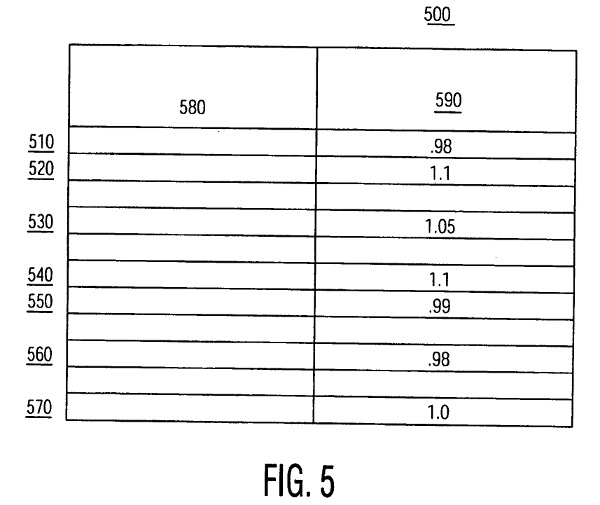

FIG. 5 is a sample table from the correction factor database of FIGS. 1 and 2;

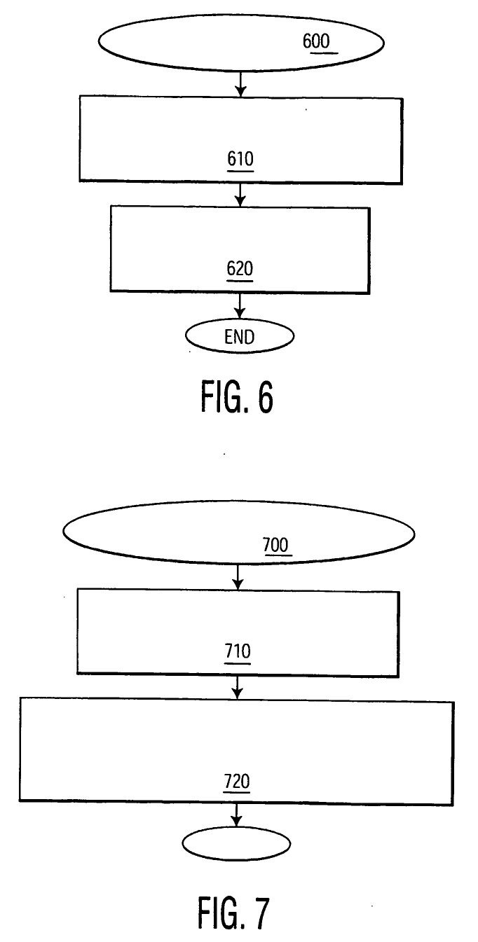

FIG. 6 is a flow chart describing an exemplary profiling process used by the audience predictor of FIG. 1;

FIG. 7 is a flow chart describing an exemplary program recommendation process used by the audience predictor of FIG. 1;

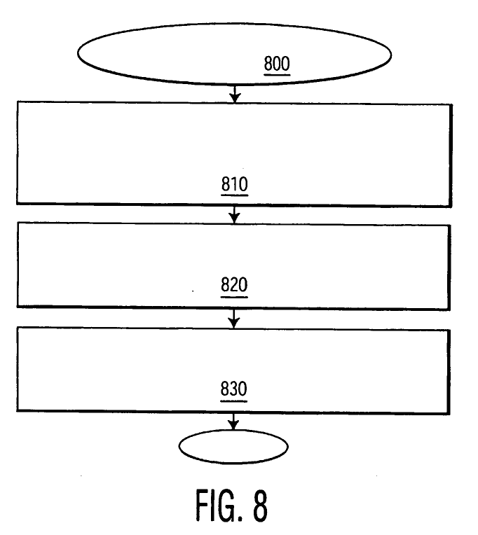

FIG. 8 is a flow chart describing an exemplary audience prediction process embodying principles of the present invention and used by the audience predictor of FIGS. 1 and 2; and

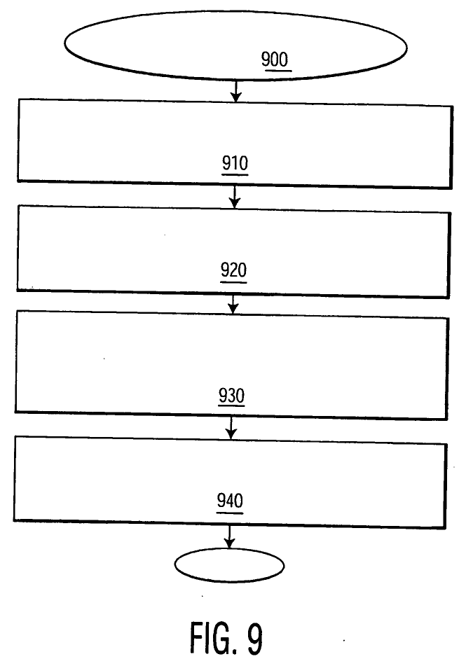

FIG. 9 is a flow chart describing an exemplary prediction bias correction process embodying principles of the present invention and used by the audience predictor of FIGS. 1 and 2.

Generally, the present invention predicts a level of interest in an item, such as the size of an audience for a television program, based on the selection history of multiple users, such as the subscribers of a cable or satellite television service provider in a geographic area, and the extent to which items are recommended to the users. In an exemplary embodiment, the present invention provides an audience predictor 100 for predicting the size of an audience for one or more programs. In this manner, if a service provider in a given geographic region collects viewing histories or program recommendations from its subscribers, the service provider can predict the size of an audience for a given program in its coverage area.

FIG. 1, discussed hereinafter, discloses a first embodiment of the present invention, where the audience predictor 100 uses the raw viewing histories of a number of users to predict the size of an audience. FIG. 2 discloses a second embodiment of the present invention, where the audience predictor 200 uses the program recommendations that were generated for a number of users to predict the size of an audience.

A service provider can predict the size of an audience for a given program based on the percentage of its subscribers to which the given program is “highly recommended.” A given program can be considered “highly recommended” to a subscriber, e.g., if the program (i) had a program recommendation score exceeding a predefined threshold; or (ii) is in a top-N list of recommended programs for the user in a given time interval. In a further variation, a given program can be considered “highly recommended” if an average recommendation score based on a plurality of users exceeds a predefined threshold or if the program is at or near the top of the recommended list (by program recommendation scores) and has a predefined gap to the next-most-recommended show. Thus, if a subscriber determines that a given program is “highly recommended” to a certain percentage of its subscribers, the subscriber can translate the “highly recommended” percentage to predict the size of the audience for the program.

In addition, another aspect provides a method for calibrating the accuracy of the predictions using actual measurement data indicating the size of the audience. The actual measurement data may be obtained, for example, from a research firm, such as Nielsen Media Research or a survey firm, or by monitoring the actual viewing of the subscribers. As discussed further below, a comparison of the predicted and actual audiences allows a correction factor to be generated to improve subsequent predictions. In this manner, the predictions will improve over time and can compensate for errors based on both sampled and unsampled users.

FIG. 1 illustrates one embodiment of an audience predictor 100 in accordance with the present invention. As shown in FIG. 1, the exemplary audience predictor 100 uses the viewing histories 120-1 through 120-N (collectively, the viewing histories 120) of a number of users to predict the size of an audience for one or more programs identified in an electronic program guide (EPG) I 0. The audience predictor I 00 may be associated, for example, with a central server of a cable or satellite service provider. In this manner, if a service provider in a given geographic region collects viewing histories 120 (or program recommendations 220) from its subscribers, the service provider is able to predict the size of an audience for a given program in its coverage area.

The audience predictor 100 can collect the viewing histories 120, for example, by directly sampling the program choices of each user or by receiving a viewing history 120 over a network from the set-top terminal or television of each user. The audience predictor 100 can communicate with the set-top terminal or television of each user in any known manner, including one or more wired or wireless links (or both). While the present invention is illustrated herein in the context of television programming predictions, the present invention can be applied to any automatically generated recommendations that are based on an evaluation of user behavior, such as a viewing history or a purchase history.

The audience predictor 100 may be embodied as any computing device, such as a personal computer or workstation, that contains a processor 150, such as a central processing unit (CPU), and memory 160, such as RAM and/or ROM. The television program recommender 100 may also be embodied as an application specific integrated circuit (ASIC), for example, in a set-top terminal or display (not shown).

As shown in FIG. 1, and discussed further below in conjunction with FIGS. 2 through 9 respectively, the memory 160 of the audience predictor 100 includes a plurality of user profiles 300, a program database 400, a correction factor database 500, a profiling process 600, a program recommendation process 700, an audience prediction process 800 and a prediction bias correction process 900. Generally, the illustrative user profiles 300 provide feature counts derived from the users' viewing histories 120. The program database 400 records information for each program that is available in a given time interval. The correction factor database 500 records a correction factor that is used to correct for any bias in the predictions generated by the present invention.

The profiling process 600 processes the viewing histories 120 to generate the corresponding user profiles 300. The program recommendation process 700 generates program recommendation scores for the programs in a time period of interest, based on the feature counts in the user profiles 300. The audience prediction process 800 predicts the size of an audience for a given television program based on the extent to which the program was recommended to the sampled users. The prediction bias correction process 900 compares the predicted audience and actual audience for a given program and generates the correction factors recorded in the correction factor database 500 and otherwise corrects for prediction errors.

FIG. 2 illustrates a second embodiment of an audience predictor 200 in accordance with the present invention. As shown in FIG. 2, the exemplary audience predictor 200 uses the program recommendations 220-1 through 220-N (collectively, the program recommendations 220) of a number of users to predict the size of an audience for one or more programs identified in an electronic program guide (EPG) 110. The audience predictor 200 may be associated, for example, with a central server of a cable or satellite service provider and can receive the program recommendations 220, for example, over a network from the program recommender, set-top terminal or television of each user.

The program recommendations 220 can be generated for each user, for example, by any available television program recommender, such as the Tivo™ system, commercially available from Tivo, Inc., of Sunnyvale, Calif., or the television program recommenders described in U.S. patent application Ser. No. 09/466,406, filed Dec. 17, 1999, entitled “Method and Apparatus for Recommending Television Programming Using Decision Trees,” U.S. patent application Ser. No. 09/498,271, filed Feb. 4, 2000, entitled “Bayesian TV Show Recommender,” and U.S. patent application Ser. No. 09/627,139, filed Jul. 27, 2000, entitled “Three-Way Media Recommendation Method and System,” or any combination thereof, each incorporated herein by reference herein.

The program recommendations 220 that are provided to the audience predictor 200 may be a top-N list of recommendations for each user, and may optionally include a recommendation score and an indication of whether the user has flagged a given program for recording (which provides a strong indicator that the user will watch the program). The audience predictor 200 predicts the size of an audience for one or more programs that are influenced by the viewing habits of multiple users and the extent to which programs are recommended to the users.

The audience predictor 200 may be embodied as any computing device, such as a personal computer or workstation, that contains a processor 250, such as a central processing unit (CPU), and memory 260, such as RAM and/or ROM. The television program recommender 200 may also be embodied as an application specific integrated circuit (ASIC), for example, in a set-top terminal.

The audience predictor 200 receives program recommendations 220 and not raw viewing histories 120 (like the audience predictor 100). Thus, the audience predictor 200 does not require the functionality required of the audience predictor 100 to process the received viewing histories 120 to generate corresponding user profiles 300 and generate recommendations therefrom. Thus, as shown in FIG. 2, and discussed further below in conjunction with FIGS. 4, 5, 8, and 9 respectively, the memory 260 of the audience predictor 200 includes only a program database 400, a correction factor database 500, an audience prediction process 800 and a prediction bias correction process 900. Thus, the embodiment shown in FIG. 2 has the added benefit that it permits making predictions while protecting the privacy (to some extent) of the users by keeping their viewing histories and user profiles private to their own boxes.

FIG. 3 is a table illustrating an exemplary implicit user profile 300. As shown in FIG. 3, the implicit user profile 300 contains a plurality of records 305-313 each associated with a different program feature. In addition, for each feature set forth in column 330, the implicit user profile 300 provides corresponding positive counts in fields 335 and negative counts in field 350. The positive counts indicate the number of times the user watched programs having each feature. The negative counts indicate the number of times the user did not watch programs having each feature.

For each positive and negative program example (i.e., programs watched and not watched), a number of program features are classified in the user profile 300. For example, if a given user watched a given sports program ten times on Channel 2 in the late afternoon, then the positive counts associated with these features in the implicit user profile 300 would be incremented by 10 in field 335, and the negative counts would be 0 (zero). Since the implicit viewing profile 300 is based on the user's viewing history 120-i, the data contained in the profile 300 is revised over time, as the viewing history grows. Alternatively, the implicit user profile 300 can be based on a generic or predefined profile, for example, selected for the user based on his or her demographics.

Although the user profile 300 is illustrated using an implicit user profile, the user profile 300 may also be embodied using an explicit profile, or a combination of explicit and implicit profiles, as would be apparent to a person of ordinary skill in the art. For a discussion of a television program recommender that employs both implicit and explicit profiles to obtain a combined program recommendation score, see, for example, U.S. patent application Ser. No. 09/666,401, filed Sep. 20, 2000, entitled “Method And Apparatus For Generating Recommendation Scores Using Implicit And Explicit Viewing Preferences,” incorporated by reference herein.

FIG. 4 is a sample table from the program database 400 of FIGS. 1 and 2 that records information for each program that is available in a given time interval. The data that appears in the program database 400 may be obtained, for example, from the electronic program guide 110. As shown in FIG. 4, the program database 400 contains a plurality of records, such as records 405 through 420, each associated with a given program. For each program, the program database 400 indicates the date/time and channel associated with the program in fields 440 and 445, respectively. In addition, the title and genre for each program are identified in fields 450 and 455. Additional well-known attributes (not shown), such as actors, duration, and description of the program, can also be included in the program database 400.

The program database 400 may also optionally record an indication of the predicted audience as determined by the audience prediction process 800 in field 480.

FIG. 5 is a table illustrating an exemplary correction factor database 500.

As shown in FIG. 5, the correction factor database 500 contains a plurality of records 510-570 each associated with a different correction factor rule. In addition, for each correction factor rule set forth in column 580, the correction factor database 500 provides corresponding correction factor in field 590. Generally, as discussed further below in conjunction with FIG. 9, the correction factor corrects for biases in a generated audience prediction.

The exemplary correction factor database 500 is accessed for a given program until a correction factor rule is satisfied. For example, the correction factor database 500 can record a correction factor for each program for which an audience was predicted by the audience predictor 100, 200 and for which actual audience measurement statistics are available. For those programs for which an actual correction factor is not available, the exemplary correction factor database 500 records a correction factor that applies to all programs of the same genre. Finally, if no correction factor rule is satisfied by a given program, the default rule in record 570 will apply a default correction factor, such as a correction factor equal to one.

FIG. 6 is a flow chart describing an exemplary profiling process 600. As previously indicated, the profiling process 600 processes the viewing histories 120 to generate the corresponding user profiles 300.

As shown in FIG. 6, the profiling process 600 initially receives the viewing histories 120 from the plurality of users during step 610. Thereafter, the profiling process 600 updates the user profiles 300 during step 620 for each user with the corresponding feature counts based on the programs that were watched (and optionally, not watched) by each user.

FIG. 7 is a flow chart describing an exemplary program recommendation process 700. As previously indicated, the program recommendation process 700 generates program recommendation scores for the programs in a time period of interest, based on the feature counts in the user profiles 300. As shown in FIG. 7, the program recommendation process 700 initially obtains the electronic program guide (EPG) 110 during step 710 for the time period of interest. Thereafter, the program recommendation process 700 calculates a program recommendation score, R, during step 720 for each sampled user for each program in the time period of interest in a conventional manner (or obtains the program recommendation score, R, from a conventional recommender). The program recommendation score, R, can optionally be recorded in the program database 400.

The individual program recommendation scores, R, calculated during step 720 may be generated, for example, using any known techniques, such as those employed by the Tivo™ system, commercially available from Tivo, Inc., of Sunnyvale, Calif., or the television program recommenders described in U.S. patent application Ser. No. 09/466,406, filed Dec. 17, 1999, entitled “Method and Apparatus for Recommending Television Programming Using Decision Trees,” U.S. patent application Ser. No. 09/498,271, filed Feb. 4, 2000, entitled “Bayesian TV Show Recommender,” and U.S. patent application Ser. No. 09/627,139, filed Jul. 27, 2000, entitled “Three-Way Media Recommendation Method and System,” or any combination thereof, each incorporated by reference herein.

FIG. 8 is a flow chart describing an exemplary audience prediction process 800. As previously indicated, the audience prediction process 800 predicts the size of an audience for a given television program based on the extent to which the program was recommended to the sampled users. As shown in FIG. 8, the audience prediction process 800 initially obtains the individual program recommendation scores, R, for the program from the program recommendation process 700 during step 810. Thereafter, the audience prediction process 800 determines the percentage of subscribers to which the program was “highly recommended” during step 820. As previously indicated, a given program can be considered “highly recommended” to a subscriber, e.g., if the program (i) had a program recommendation score exceeding a predefined threshold; or (ii) is in a top-N list of recommended programs for the user in a given time interval. For example, a histogram can be generated during step 820 indicating the number of users to which each program was highly recommended.

Finally, the audience prediction process 800 predicts the audience for the program based on the “highly recommended” percentage during step 830. In one implementation, the predicted audience is equal to the “highly recommended” percentage (normalized to 100%) multiplied by the correction factor for the program (as generated by the prediction bias correction process 900 and recorded in the correction factor database 500).

It is noted that the histogram generated during step 820 will fail to include some sampled users in the count at all, if their recommendations fail to rise to the level of “highly recommended,” and will include some sampled users more than once, if more than one program in a given time slot is “highly recommended.” In other words, in a given time slot, a user may have zero to many “highly recommended” programs. Generally, the effectiveness of a recommendation tool increases over time as the user interacts with the system, and it becomes more likely that only a single program is highly recommended for a given time slot. In this regard, the predictions will “self correct” as the viewing histories 120 of the multiple users increase over time.

Thus, the audience predictor 100, 200 optionally employs a feedback feature to automatically update the feature counts for the users in the viewing histories 120 (incrementing the feature counts for unwatched programs for all users with multiple “highly recommended” programs in a given time slot, and incrementing the feature counts for watched programs for all users with no “highly recommended” programs in a given time slot). The implicit recommender increments all features for all watched programs regardless of recommendations (and similarly for not-watched programs). Furthermore, the user may elect to provide feedback on his or her own—telling the system that he or she likes or dislikes particular programs. It is assumed that users will be most motivated to give feedback in response to poor recommendations.

FIG. 9 is a flow chart describing an exemplary prediction bias correction process 900. As previously indicated, the prediction bias correction process 900 compares the predicted audience and actual audience for a given program and generates the correction factors recorded in the correction factor database 500 and otherwise corrects for prediction errors. As shown in FIG. 9, the prediction bias correction process 900 initially obtains the predicted audience for a given program during step 910. Thereafter, the prediction bias correction process 900 obtains the actual audience for a given program during step 920, for example, from a research firm, such as Nielsen Media Research or a survey firm, or by monitoring the actual viewing of the subscribers. Finally, the current correction factor for the program is adjusted during step 930 by a predefined percentage (such as 10%) of the difference between the predicted audience and the actual audience. For example, if a predicted audience for a given program is 20% and the actual audience was 30%, then an initial correction factor of 1.0 would be adjusted by 10% of the difference to provide a new correction factor of 1.01 (1.0+(10%*10%)=1.01) It is noted that a program not previously processed by the prediction bias correction process 900 will have a correction factor of one. The new correction factor, if any, is recorded for the program in the correction factor database 500 during step 940.

It is to be understood that the embodiments and variations shown and described herein are merely illustrative of the principles of this invention and that various modifications may be implemented by those skilled in the art without departing from the scope and spirit of the invention.

1. A method for predicting a level of interest in an available item, comprising the steps of:
obtaining one or more recommendation scores for said available item based on a history of selecting said available item by a plurality of individuals; and
predicting a level of interest in said available item based on said one or more recommendation scores.

2. The method of claim 1, wherein said one or more recommendation scores for said available item is a unique recommendation score for each of said plurality of individuals.

3. The method of claim 1, wherein said one or more recommendation scores for said available item is an aggregate recommendation score for said plurality of individuals.

4. The method of claim 1, wherein said obtaining step further comprises the step of averaging a plurality of recommendation scores for said available item.

5. The method of claim 1, wherein said obtaining step further comprises the step of receiving said one or more recommendation scores from at least one remote recommender.

6. The method of claim 1, wherein said obtaining step further comprises the step of receiving said history of selecting from at least one remote recommender.

7. The method of claim 1, further comprising the step of comparing said predicted level of interest to an actual level of interest and generating a correction factor to compensate for errors in said predicted level of interest.

8. The method of claim 1, further comprising the step of updating said history of selecting based on whether said available item was actually selected by at least one of said plurality of individuals.

9. The method of claim 1, wherein said available item is a program and said level of interest is a size of an audience for said program.

10. The method of claim 1, wherein said available item is content and said level of interest is a size of an audience for said content.

11. The method of claim 1, wherein said available item is a product and said level of interest is a number of customers who will purchase said product.

12. The method of claim 1, wherein said plurality of individuals are subscribers of a service provider in one or more geographic areas.

13. The method of claim 1, wherein said level of interest is based on a percentage of said plurality of individuals to which said available item is highly recommended.

14. The method of claim 13, wherein an available item is highly recommended if the item had a recommendation score exceeding a predefined threshold.

15. The method of claim 13, wherein an available item is highly recommended if the item is in a top-N list of recommended items for at least one of said plurality of individuals.

16. The method of claim 1, further comprising the step of adjusting a price of advertising associated with said item based on said predicted level of interest.

17. The method of claim 1, further comprising the step of adjusting a content of advertising associated with said item based on demographic information of individuals who are predicted to be interested in said item.

18. The method of claim 1, further comprising the step of determining a number of said items to produce based on said predicted level of interest.

19. An apparatus for predicting a level of interest in an available item, comprising:
a memory; and
at least one processor, coupled to the memory, operative to:
obtain one or more recommendation scores for said available item based on a history of selecting said available item by a plurality of individuals; and
predict a level of interest in said available item based on said one or more recommendation scores.

20. The apparatus of claim 19, wherein said processor is further configured to compare said predicted level of interest to an actual level of interest and generate a correction factor to compensate for errors in said predicted level of interest.

21. The apparatus of claim 19, wherein said processor is further configured to update said history of selecting based on whether said available item was actually selected by at least one of said plurality of individuals.

22. The apparatus of claim 19, wherein said available item is a program and said level of interest is a size of an audience for said program.

23. The apparatus of claim 19, wherein said level of interest is based on a percentage of said plurality of individuals to which said available item is highly recommended.

24. The apparatus of claim 23, wherein an available item is highly recommended if the item had a recommendation score exceeding a predefined threshold.

25. The apparatus of claim 23, wherein an available item is highly recommended if the item is in a top-N list of recommended items for at least one of said plurality of individuals.

26. The apparatus of claim 19, wherein said processor is further configured to adjust a price of advertising associated with said item based on said predicted level of interest.

27. The apparatus of claim 19, wherein said processor is further configured to adjust content of advertising associated with said item based on demographic information of individuals who are predicted to be interested in said item.

28. An article of manufacture for predicting a level of interest in an available item, comprising:
a machine readable medium containing one or more programs which when executed implement the steps of:
obtaining one or more recommendation scores for said available item based on a history of selecting said available item by a plurality of individuals; and
predicting a level of interest in said available item based on said one or more recommendation scores.
